(19) United States
(12) Patent Application Publication
(10) Pub. No.: US 2015/0195237 A1
(43) Pub. Date: Jul. 9, 2015

(54) MAIL EXTRACTION METHOD, MAIL EXTRACTION DEVICE, AND PROGRAM

(71) Applicant: FUJITSU LIMITED, Kawasaki-shi (JP)

(72) Inventors: Yoshitaka KATO, Kamitakai (JP); Masahiro KAWASAKI, Kawasaki (JP); Keiko GOTO, Ota (JP)

(73) Assignee: FUJITSU LIMITED, Kawasaki (JP)

(21) Appl. No.: 14/645,976

(22) Filed: Mar. 12, 2015

Related U.S. Application Data
(63) Continuation of application No. PCT/JP2012/075717, filed on Oct. 3, 2012.

(51) Int. Cl. H04L 12/58

(52) U.S. Cl. CPC H04L 51/22

(57) ABSTRACT

A mail extraction method causes a computer to execute processes including storing, in association with each other in a storage unit, a first mail sent to a plurality of destinations, a first return mail from a first destination among the plurality of destinations, and a first re-return mail that is returned to the first return mail; and displaying, on a display unit, the first re-return mail stored in the storage unit in association with the first mail, in response to a request to create a second re-return mail to a second return mail from a second destination among the plurality of destinations of the first mail.

### CROSS-REFERENCE TO RELATED APPLICATION

This application is a U.S. continuation application filed under 35 USC 111(a) claiming benefit under 35 USC 120 and 365(c) of PCT Application PCT/JP2012/075717 filed on Oct. 3, 2012, the entire contents of which are incorporated herein by reference.

### FIELD

The present invention is related to a mail extraction method, a mail extraction device, and a program.

### BACKGROUND

In response to an e-mail sent to a plurality of destinations, there are cases where the same question and the same opinion are returned from a plurality of persons. In this case, the user returns the same message that has already been returned, again. For example, the user searches for an e-mail that has already been returned, and copies the message in this e-mail into a new mail to be returned.

Patent Document 1: Japanese Laid-Open Patent Publication No. H10-303975

However, under circumstances where a large number of e-mails are sent and received every day, it is a troublesome operation for the user to search for the target return mail, from among a large number of e-mails.

### SUMMARY

According to one idea, a mail extraction method causes a computer to execute processes including storing, in association with each other in a storage unit, a first mail sent to a plurality of destinations, a first return mail from a first destination among the plurality of destinations, and a first re-return mail that is returned to the first return mail; and displaying, on a display unit, the first re-return mail stored in the storage unit in association with the first mail, in response to a request to create a second re-return mail to a second return mail from a second destination among the plurality of destinations of the first mail.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF DRAWINGS

FIG. 1 is a diagram indicating a configuration example of a mail system according to the present embodiment.

FIG. 2 is a diagram indicating a hardware configuration example of a mail server according to the present embodiment.

FIG. 3 is a diagram indicating a functional configuration example of the mail system according to the present embodiment.

FIG. 4 is a flowchart for describing processing procedures executed by the mail server.

FIG. 5 is a diagram indicating a configuration example of a user information storage unit.

FIG. 6 is a diagram indicating a configuration example of a mail DB in a mail storage unit.

FIG. 7 is a diagram indicating a display example of a reception mail list screen.

FIG. 8 is a diagram indicating a display example of a return mail creating screen.

FIG. 9 is a flowchart for describing an example of processing procedures of a return mail creating screen generation process.

FIG. 10 is a diagram indicating a configuration example of a return relationship storage unit.

FIG. 11 is an example of processing procedures of a divert candidate selection area generation process.

FIG. 12 is a diagram indicating a configuration example of a selection item information storage unit.

FIG. 13 is a diagram indicating a configuration example of an answer status storage unit.

FIG. 14 is a flowchart for describing an example of processing procedures of an additional destination candidate button inversion process.

FIG. 15 is a flowchart for describing the processing procedures of a return mail creating screen operation process.

FIG. 16 is a diagram indicating a display example of a return mail creating screen to which the destination has been added and the body text has been diverted.

FIG. 17 is a diagram indicating an example of a state of a return relationship storage unit after a present mail has been returned.

### DESCRIPTION OF EMBODIMENTS

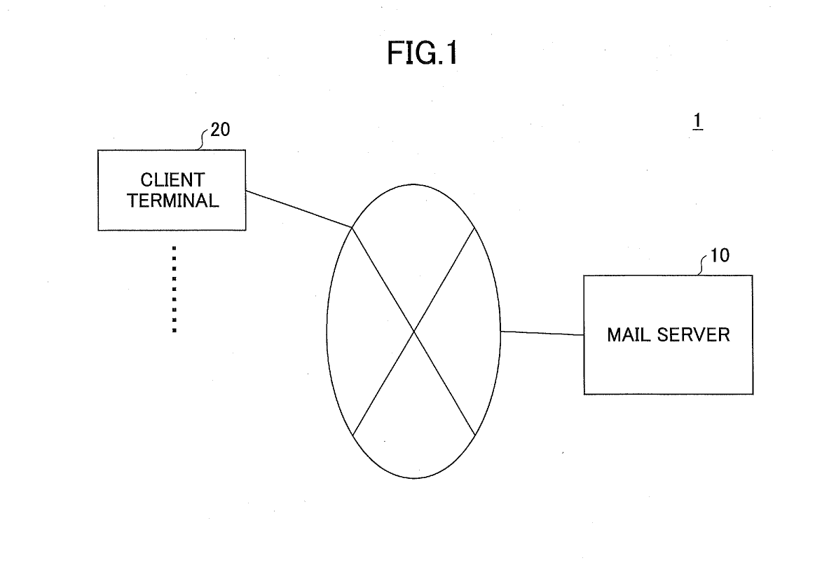

In the following, embodiments of the present invention are described with reference to drawings. FIG. 1 is a diagram indicating a configuration example of a mail system according to the present embodiment.

In a mail system 1 indicated in FIG. 1, a mail server 10 and a plurality of client terminals 20, etc., are able to communicate with each other via a network such as a LAN (Local Area Network) or the Internet. Part of the network may be wireless.

The mail server 10 is one or more computers for providing a Web mail service in a format of, for example, a service or a cloud service, etc., in the intranet. In the Web mail service, the reception mails and transmission mails, etc., of the respective users are managed by the mail server 10 that is the server side.

The client terminal 20 is a terminal used by the user of the Web mail service. An example of the client terminal 20 is a PC (Personal Computer), a mobile phone, a smartphone, a tablet type terminal, etc.

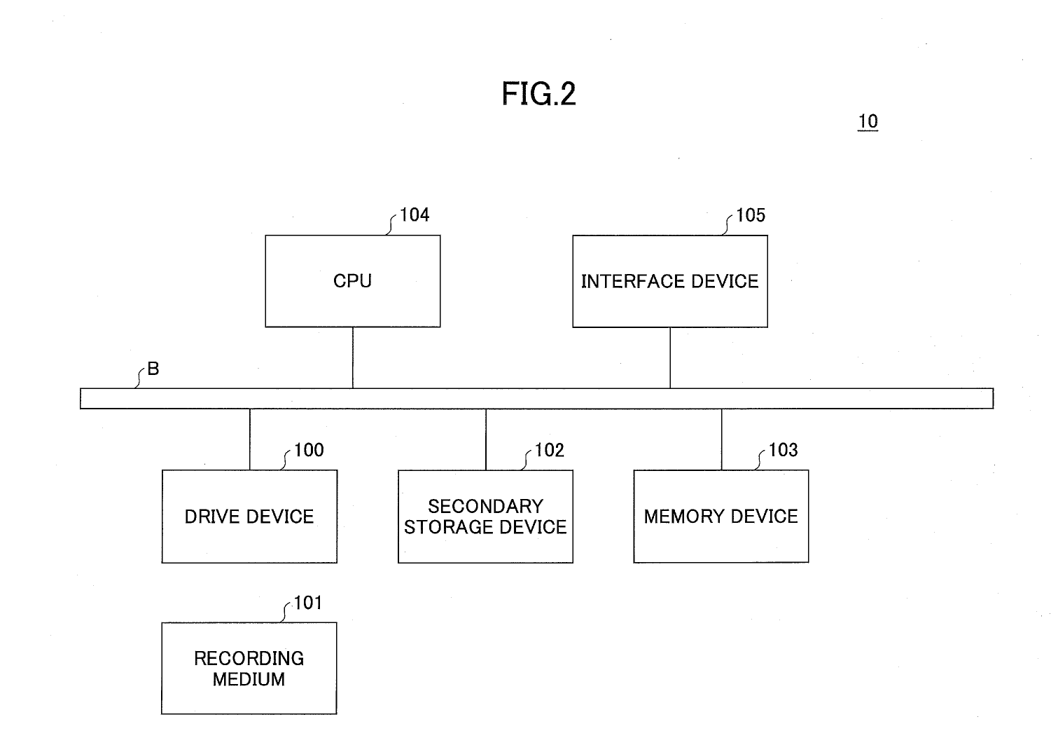

FIG. 2 is a diagram indicating a hardware configuration example of the mail server according to the present embodiment. The mail server 10 of FIG. 2 includes a drive device 100, a secondary storage device 102, a memory device 103, a CPU 104, an interface device 105, etc., which are interconnected by a bus B.

Programs for realizing processes at the mail server 10 are provided by a recording medium 101. When the recording medium 101 recording a program is set in the drive device 100, the program is installed in the secondary storage device 102 from the recording medium 101 via the drive device 100. However, a program does not always need to be installed from the recording medium 101; a program may be downloaded from another computer via the network. The secondary storage device 102 stores the installed programs and also stores the needed files and data, etc.

When an instruction to activate a program is given, the memory device 103 reads the program from the secondary storage device 102 and stores the program. The CPU 104 executes functions relevant to the mail server 10 according to the programs stored in the memory device 103. The interface device 105 is used as an interface for connecting to the network.

Note that as an example of the recording medium 101, there is a portable recording medium such as a CD-ROM, a DVD disk, a USB memory, etc. Furthermore, as an example of the secondary storage device 102, there is a HDD (Hard Disk Drive), a flash memory, etc. Both the recording medium 101 and the secondary storage device 102 correspond to a computer-readable recording medium.

Note that the client terminal 20 may also have the hardware as indicated in FIG. 2.

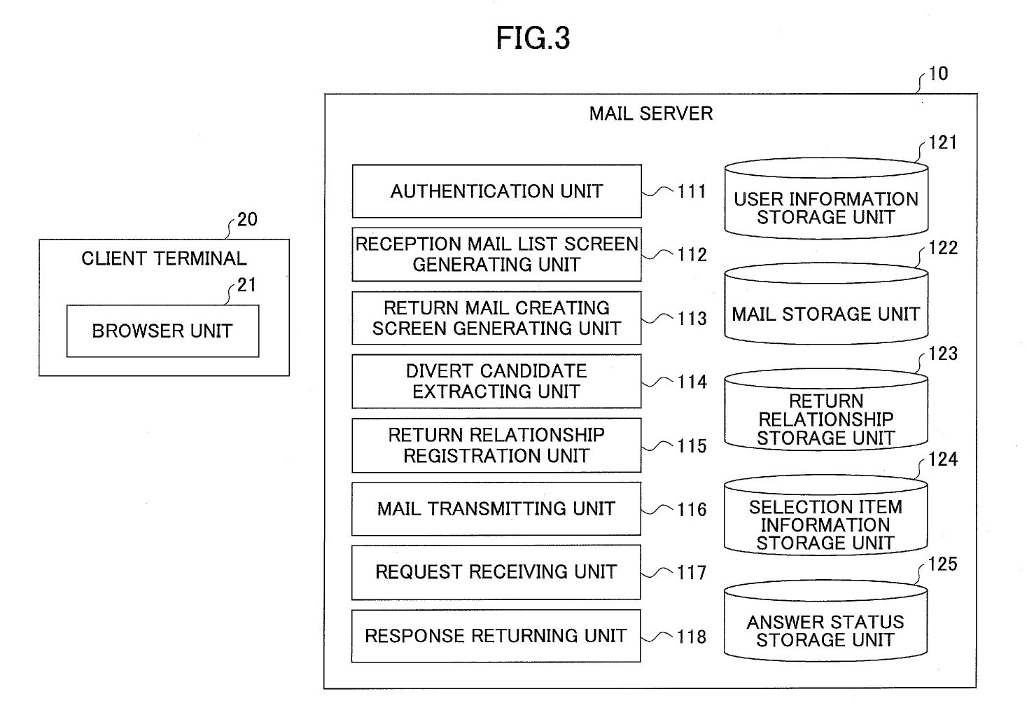

FIG. 3 is a diagram indicating a functional configuration example of the mail system according to the present embodiment. In FIG. 3, the mail server 10 includes an authentication unit 111, a reception mail list screen generating unit 112, a return mail creating screen generating unit 113, a divert candidate extracting unit 114, a return relationship registration unit 115, a mail transmitting unit 116, a request receiving unit 117, a response returning unit 118, etc. These units are realized by processes that the CPU 104 is caused to execute by one or more programs installed in the mail server 10.

The mail server 10 further uses a user information storage unit 121, a mail storage unit 122, a return relationship storage unit 123, a selection item information storage unit 124, an answer status storage unit 125, etc. These storage units may be realized by using the secondary storage device 102 or a storage unit connected to the mail server 10 via the network, etc.

The request receiving unit 117 receives a request from the client terminal 20. The authentication unit 111 executes a process of authenticating the user of the Web mail service. The reception mail list screen generating unit 112 generates screen data of a screen for displaying a list of reception mails (hereinafter, “reception mail list screen”) of the authenticated users. The screen data may be generated by using HTML (HyperText Markup Language) and script, etc. The return mail creating screen generating unit 113 generates screen data of a screen (hereinafter, “return mail creating screen”) for causing the user to create a return mail to a certain mail. The return mail includes a return mail to be returned to a return mail (that is to say, re-return a mail), etc.

The divert candidate extracting unit 114 extracts a mail to be a divert candidate of a return mail to be newly created from among the past return mails. The return relationship registration unit 115 registers, in the return relationship storage unit 123, association information between the source mail to which a mail is to be returned and the return mail to be returned to the source mail. The mail transmitting unit 116 sends a mail relevant to a transmission request, to the destination. The response returning unit 118 returns a response according to a request from the client terminal 20, to the client terminal 20. For example, the response includes any one of the screen data described above.

The user information storage unit 121 stores attribute information of each user of the Web mail service provided by the mail server 10. The mail storage unit 122 stores the information of the reception mail or the transmission mail, for each user. The return relationship storage unit 123 stores, for each return mail, the association information between the source mail to which a mail is to be returned and the return mail to be returned to the source mail. There are cases where the returning of a mail is repeated, such as re-returning a mail and re-re-returning a mail. The return relationship storage unit 123 also stores the association information between a return mail and the new mail that is the origin of the repeated return mails. The selection item information storage unit stores information relevant to a selection item in a list box displayed in the return mail creating screen. The answer status storage unit 125 stores information indicating the answer status from each user, for each mail requesting an answer.

The client terminal 20 includes a browser unit 21, etc. The browser unit 21 is realized by processes that the CPU of the client terminal 20 is caused to execute by programs installed in the client terminal 20. The browser unit 21 causes the display device of the client terminal 20 to display a screen based on screen data generated by the mail server 10, and sends a request to the mail server 10 according to input to the screen.

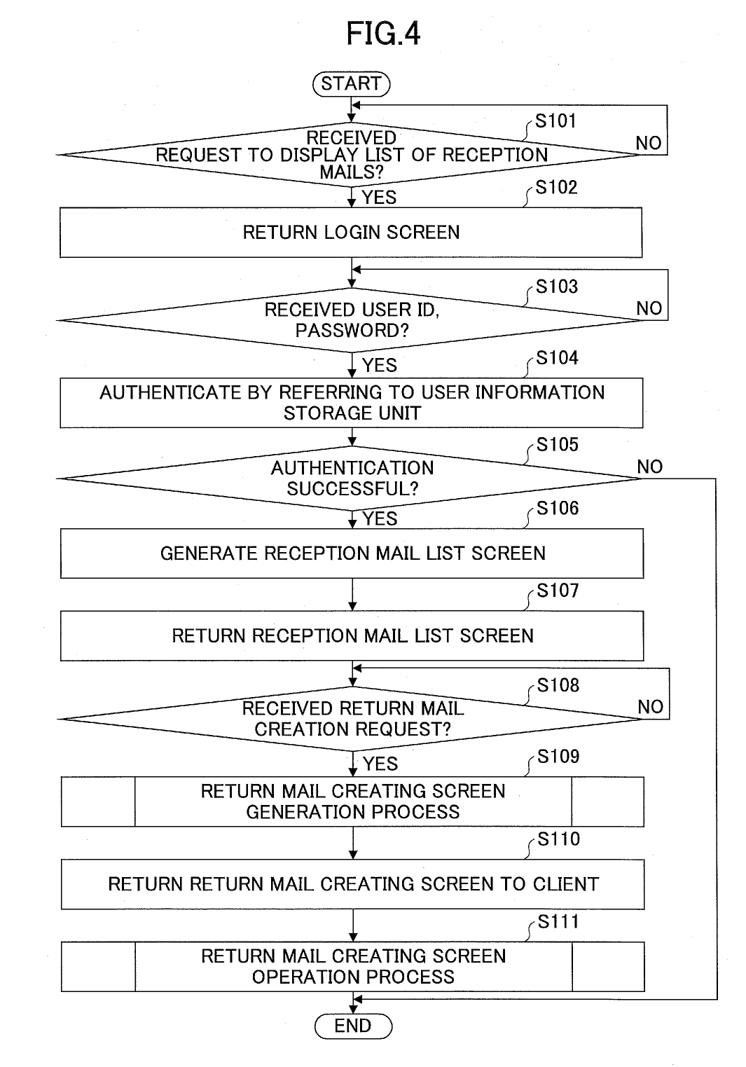

In the following, a description is given of processing procedures executed by the mail server 10 in the mail system 1. FIG. 4 is a flowchart for describing processing procedures executed by the mail server.

The request receiving unit 117 of the mail server 10 waits to receive a request from the client terminal 20. When the request receiving unit 117 receives, from one of the client terminals 20, a request to display a list of reception mails (YES in step S101), the authentication unit 111 returns, to the client terminal 20, a response including screen data for displaying a login screen (step S102). A login screen is a screen for inputting a user ID and a password. The browser unit 21 of the client terminal 20 that has received the response displays a login screen based on the screen data included in the response. The user inputs a user ID and a password in the login screen. Note that in the present embodiment, the mail address of each user is used as the user ID of the corresponding user. When a login instruction is input in the login screen, the browser unit 21 sends, to the mail server 10, a login request in which the input user ID and password are specified.

When the request receiving unit 117 of the mail server 10 receives a login request in which the input user ID and password are specified (YES in step S103), the authentication unit 111 refers to the user information storage unit 121 and executes an authentication request with respect to the user ID and password (step S104).

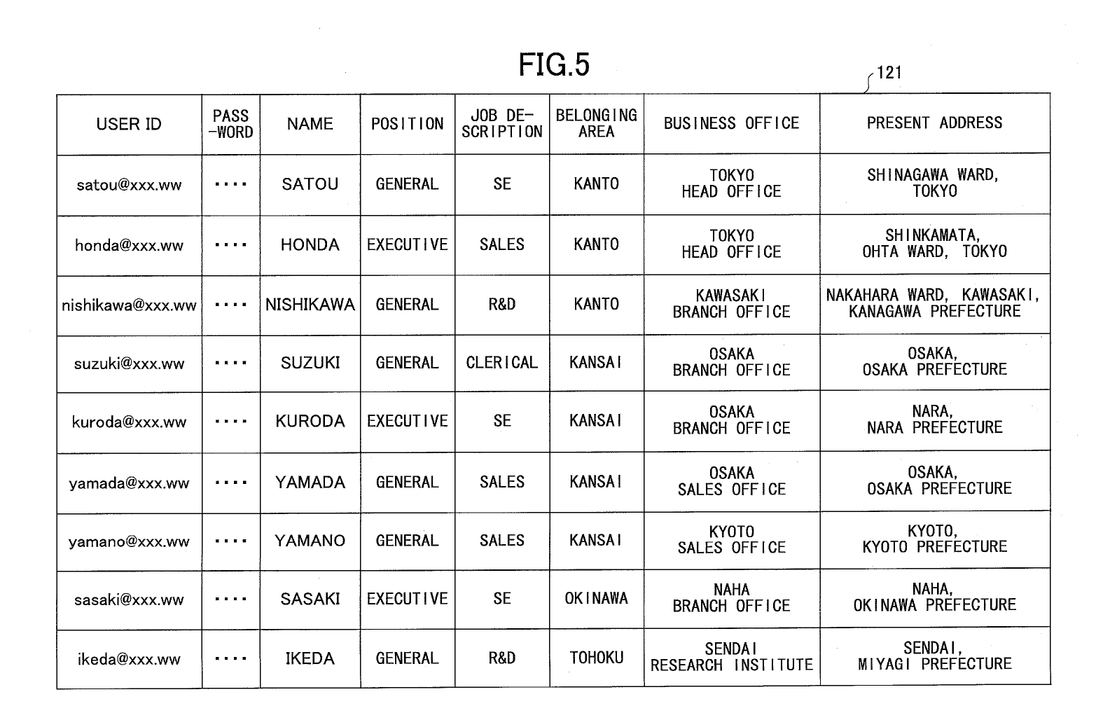

FIG. 5 is a diagram indicating a configuration example of the user information storage unit. In FIG. 5, the user information storage unit 121 stores, for each user, attribute information including a user ID, a password, a name, a position, a job description, a belonging area, a business office, and the present address.

The user ID is identification information of each user, and is also the mail address of a user. A password is the password of a user. The name is the name of a user. The position and job description are the position and job description of a user. The belonging area is the belonging area to which the work location of the user belongs. In the present embodiment, the belonging area is divided into the segments of “Tohoku”, “Kanto”, “Kansai”, and “Okinawa”. Note that when there are users who belong to Hokkaido and Shikoku, “Hokkaido” and “Shikoku” may be included as the segments. Furthermore, when there is are users who belong overseas, the segments of country names and state names may be included. The business office is the business office to which the user belongs. The present address is the home address of the user.

In the authentication process of step S104, when a record including the user ID and password specified in the login request, is stored in the user information storage unit 121, it is determined that the authentication is successful. When the authentication is successful, the user ID specified in the login request is stored as a login user ID in, for example, the memory device 103. When a record including the user ID and password specified in the login request, is not stored in the user information storage unit 121, it is determined that the authentication is unsuccessful. Note that when the authentication is successful, for example, typical session management is implemented between the client terminal 20 and the mail server 10. Therefore, even when the mail server 10 is handling a plurality of the client terminals 20 in parallel, the mail server 10 is able to identify the login user ID corresponding to the request from each client terminal 20.

When the authentication is unsuccessful (NO in step S105), the process of FIG. 4 ends. When the authentication is successful (YES in step S105), the reception mail list screen generating unit 112 generates screen data for displaying a reception mail list screen (step S106). In generating the screen data, the reception mail list screen generating unit 112 acquires, from the mail storage unit 122, a list of reception mails corresponding to the login user ID.

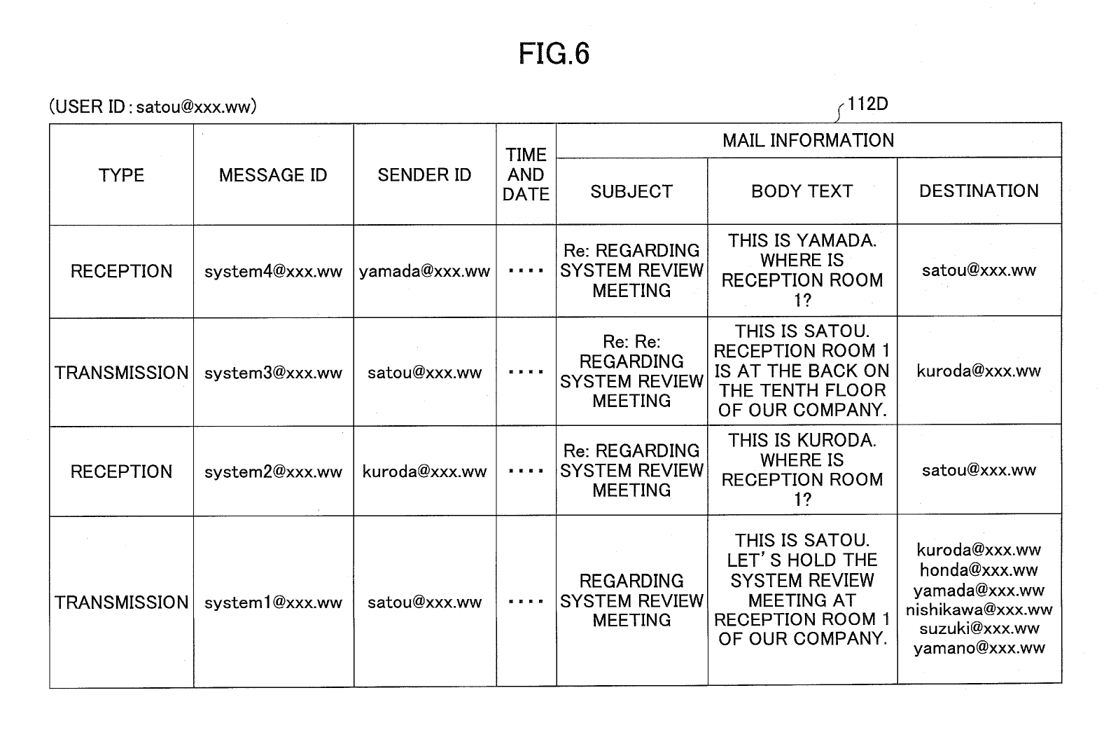

FIG. 6 is a diagram indicating a configuration example of a mail DB in the mail storage unit. The mail storage unit 122 stores a mail DB (DataBase) 112D for each user (user ID). The mail DB 112D indicated in FIG. 6 is a mail DB 112D corresponding to the user whose user ID is “satou@xxx.ww” (hereinafter, referred to as “user satou”). In the present embodiment, it is assumed that the user satou is the login user.

Each mail DB 112D stores a record for, for example, each transmission mail or reception mail. Each record stores values of items such as the type, the message ID, the sender ID, mail information, etc.

The type is the type indicating whether the mail is a transmission mail or a reception mail. The message ID is identification information of each mail. The sender ID is the user ID of the transmission source of the mail. The mail information is the contents of the mail. FIG. 6 indicates an example in which the mail information is constituted by a subject, a body text, and a destination. The subject is the title or subject of the mail. The body text is a character string in the body text of the mail. The destination is the destination address of the mail. With respect to a mail that is transmitted to a plurality of destinations, a plurality of the destination addresses are stored.

In step S102, the reception mail list screen generating unit 112 extracts a record whose “type” value is “reception”, from the mail DB 112D of the user satou. The reception mail list screen generating unit 112 generates screen data for displaying a reception mail list screen, based on the extracted record.

Next, the response returning unit 118 returns a response including the screen data, to the client terminal 20 (step S107). The browser unit 21 of the client terminal 20 that has received the response displays a reception mail list screen based on the screen data included in the response.

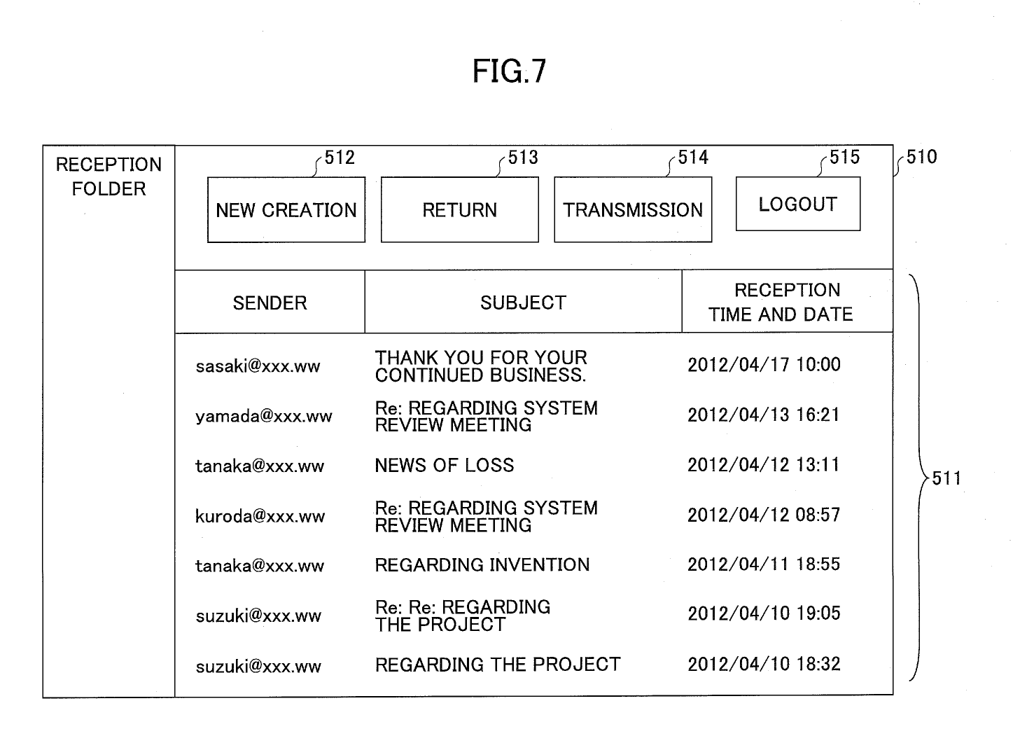

FIG. 7 is a diagram indicating a display example of a reception mail list screen. In FIG. 7, a reception mail list screen 510 includes a reception mail list area 511, a new creation button 512, a return button 513, a transmission button 514, and a logout button 515.

In the reception mail list area 511, the sender, the subject, and the reception time and date are displayed, for each reception mail. As the sender, the subject, and the reception time and date, the values of the “sender ID”, the “subject”, and the “time and date” in the mail DB 112D (FIG. 6), are displayed.

The new creation button 512 is a button for receiving an instruction to create a new mail. The return button 513 is a button for receiving an instruction to create a return mail to a reception mail that is being selected in the reception mail list area 511. The transmission button 514 is a button for receiving an instruction to create a transmission mail to the reception mail being selected in the reception mail list area 511. The logout button 515 is a button for receiving a logout instruction.

In the reception mail list screen 510, when the return button 513 is pressed, the browser unit 21 of the client terminal 20 sends a return mail creation request to the mail server 10. In the return mail creation request, the message ID of the mail selected in the reception mail list area 511, is specified. Note that the mail selected in the reception mail list area 511, i.e., the source mail to which a mail is to be returned, is hereinafter referred to as a “source mail”.

When the request receiving unit 117 of the mail server 10 receives the return mail creation request (YES in step S108), the mail server 10 executes a return mail creating screen generation process (step S109). Details of the return mail creating screen generation process are described below. Next, the response returning unit 118 returns, to the client terminal 20, a response including the screen data generated in the return mail creating screen generation process (step S110). The browser unit 21 of the client terminal 20 that has received this response, displays a return mail creating screen, based on the screen data included in the response.

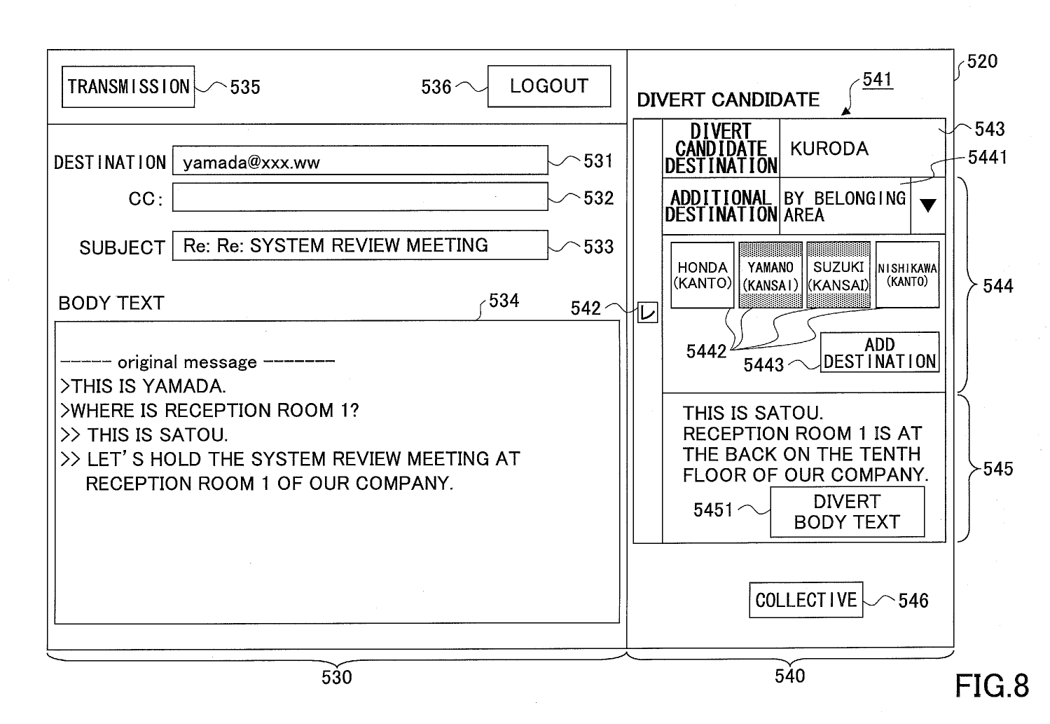

FIG. 8 is a diagram indicating a display example of a return mail creating screen. A return mail creating screen 520 illustrated in FIG. 8 includes, in the left-right direction (horizontal direction), a return mail operation area 530 and a divert candidate selection area 540.

The return mail operation area 530 includes a destination input area 531, a CC input area 532, a subject input area 533, a body text input area 534, a transmission button 535, and a logout button 536.

The destination input area 531 and the CC input area 532 are input areas for inputting the mail address of the destination or the mail address of the CC (carbon copy). The subject input area 533 is the input area of the subject of the mail. The body text input area 534 is the input area of the body text of the mail.

The transmission button 535 is a button for receiving an instruction to send a mail. The logout button 536 is a button for receiving a logout instruction.

Note that in the destination input area 531, the mail address of the source mail is set. In the subject input area 533, a character string is set, in which the subject of the source mail is appended with a character string (“Re:”) indicating a return mail. In the body text input area 534, the character strings (message) of the source mail are quoted.

Note that in the present embodiment, in the mail DB 112D indicated in FIG. 6, it is assumed that the reception mail stored in the first record, i.e., the reception mail whose message ID is “system4@xxx.ww”, is the source mail. Therefore, in each of the destination input area 531, the subject input area 533, and the body text input area 534, the sender ID, the subject name, and the quotation of the body text of the record, are set. Note that “Re:” is appended to the subject name of the source mail. Therefore, it is known that the return mail is returned to a mail having a source mail. That is to say, the return mail to be created, is a re-return mail. Note that a re-return mail to be created is hereinafter referred as the “present mail”.

Meanwhile, the divert candidate selection area 540 is an area for prompting the selection of a divert candidate, etc., and includes a divert candidate display area 541 for each divert candidate and a collective button 546, etc. Note that FIG. 8 corresponds to an example where the number of divert candidates is one, and therefore only one divert candidate display area 541 is displayed.

A divert candidate is a candidate mail whose body text is to be diverted into the body text of the present mail, among past return mails. In the return mail creating screen generation process described below, among return mails that the user satou has sent in the past, a mail whose body text is relatively highly likely to be diverted into the body text of the present mail, is extracted as a divert candidate.

Each divert candidate display area 541 includes a check button 542, a divert candidate destination display area 543, an additional destination selection area 544, and a divert text display area 545.

The check button 542 is a check button for selecting a divert candidate as the divert target. The check button 542 is particularly effective when there are a plurality of the divert candidates and a plurality of the divert candidate display areas 541 are included.

In the divert candidate destination display area 543, the name of the user relevant to the destination mail address of the divert candidate (that is to say, the name of the user that is the destination of the divert candidate) is displayed.

It is known that the divert candidate of FIG. 8 is a mail that has been returned in the past from the user satou to Mr. Kuroda.

The additional destination selection area 544 is an area for prompting the selection of a destination to be further added as the destination of the present mail (hereinafter, “additional destination”). The additional destination selection area 544 includes a list box 5441, an additional destination candidate button 5442, and a destination addition button 5443.

The additional destination candidate button 5442 is provided for each user that is a candidate of the additional destination, and is a button for prompting the selection of a user to be the additional destination. In FIG. 8, four additional destination candidate buttons 5442 are displayed. That is to say, it is known that four people are set as candidates of the additional destination. A description of how a candidate of an additional destination is extracted, is given below.

The list box 5441 is a display component for prompting the selection of a standard for narrowing down the user to be the additional destination, from among the candidates of the additional destination. The example of FIG. 8 indicates an example where “z” is selected as the standard of narrowing down the additional destination. That is to say, this example indicates that the belonging area is used as the standard for narrowing down the additional destination. The additional destination candidate button 5442, which corresponds to the candidate that has been narrowed down as the additional destination, is displayed in an inverted manner.

The destination addition button 5443 is a button for receiving an instruction to add, as the destination of the present mail, the user corresponding to the additional destination candidate button 5442 that is displayed in an inverted manner. That is to say, when the destination addition button 5443 is pressed, the user ID (mail address) of the user corresponding to the additional destination candidate button 5442 displayed in an inverted manner, is added to the destination input area 531.

The divert text display area 545 includes the body text of the divert candidate as well as a body text divert button 5451. The body text divert button 5451 is a button for receiving an instruction to divert the body text. That is to say, when the body text divert button 5451 is pressed, the character strings of the body text are inserted in the body text input area 534.

The collective button 546 is a button for collectively receiving instructions respectively received by the destination addition button 5443 and the body text divert button 5451. That is to say, when the collective button 546 is pressed, the same processes as that of the case where both the destination addition button 5443 and the body text divert button 5451 are pressed, are performed.

Referring back to FIG. 4, after step S110, the mail server 10 executes a return mail creating screen operation process (step S111). In the return mail creating screen operation process, a process like a dialogue is executed, according to operations by the user asked with respect to the return mail creating screen 520.

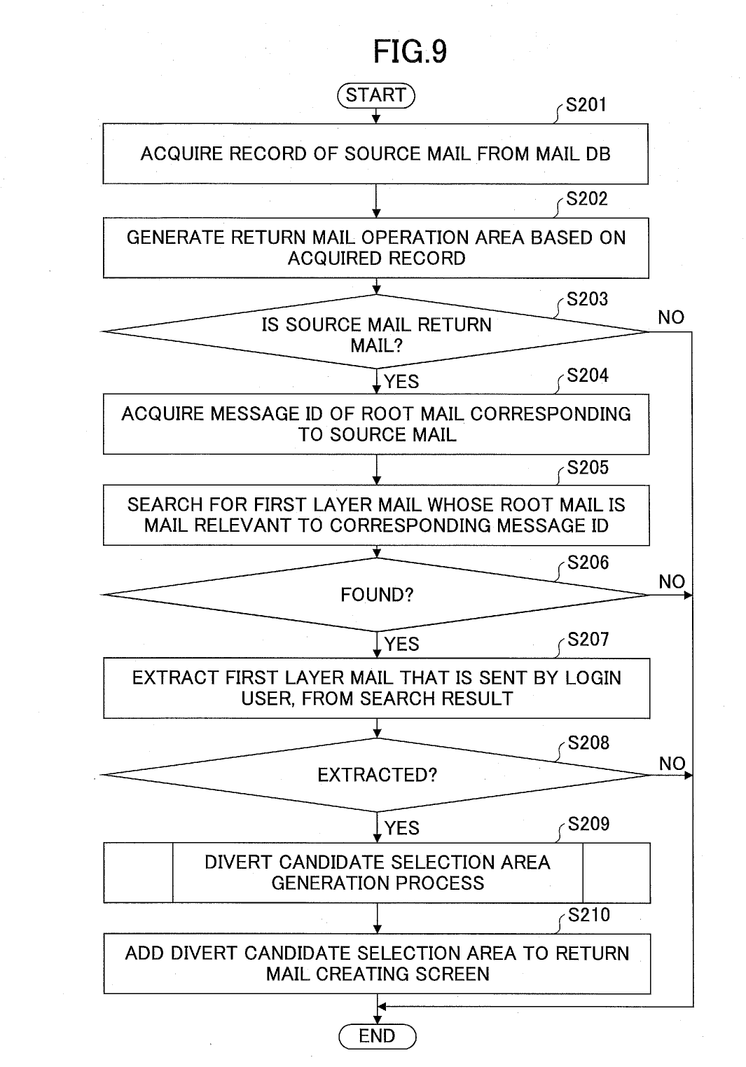

Next, a description is given of details of step S109. FIG. 9 is a flowchart for describing an example of processing procedures of the return mail creating screen generation process.

In step S201, the return mail creating screen generating unit 113 acquires the record of a source mail from the mail DB 112D (FIG. 6) corresponding to the user satou who is the login user, based on the message ID of the source mail received in step S108. Here, the source mail is a mail whose message ID is “system4@xxx.ww”.

Next, the return mail creating screen generating unit 113 generates a part corresponding to the return mail operation area 530, in the screen data of the return mail creating screen 520 (FIG. 8), based on the acquired record (step S202). That is to say, the sender ID of the record is set in the destination input area 531. Furthermore, a character string appended with “Re:” before the subject of the record is set in the subject input area 533. Furthermore, in the body text input area 534, a character string, which is obtained by turning the body text of the record into a quotation format, is set.

Next, the return mail creating screen generating unit 113 determines the mail to which the source mail has been returned as a return mail (step S203). This determination is made by referring to the return relationship storage unit 123.

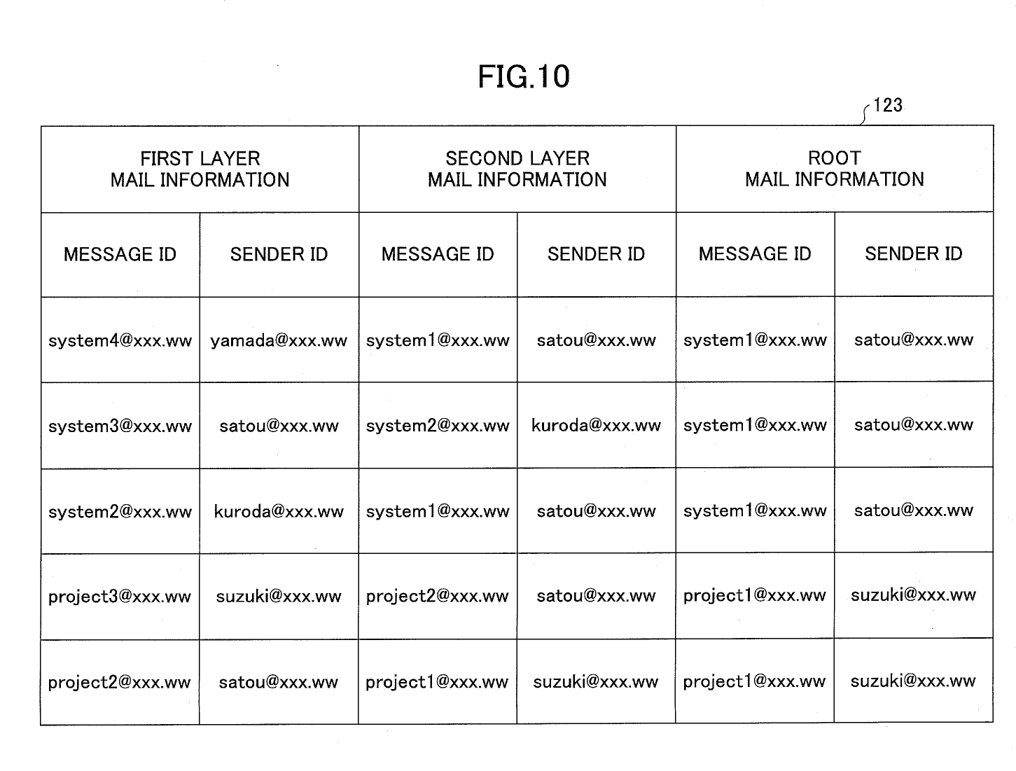

FIG. 10 is a diagram indicating a configuration example of the return relationship storage unit. The return relationship storage unit 123 stores first layer mail information, second layer mail information, and root mail information, in association with each other. The first layer mail information, the second layer mail information, and the root mail information, respectively include the message ID of a first layer mail and the user ID (sender ID) of the sender of the first layer mail, the message ID of a second layer mail and the user ID (sender ID) of the sender of the second layer mail, and the message ID of a root mail and the user ID (sender ID) of the sender of the root mail.

The root mail is a newly created mail, and is a mail that is not a return mail to any mail. The first layer mail is a return mail to the second layer mail. The second layer mail is the mail that is the source to which the first layer mail is returned. The second layer mail corresponds to any mail in the procedure of repeating to return a mail one or more times, in which the root mail is the origin. The second layer mail may be a return mail that is directly returned to the root mail, or may be the root mail.

Note that the record of the return relationship storage unit 123 is generated every time a mail is returned. For example, it is assumed that a mail B is returned to a newly created mail A. The root mail and the second layer mail of the record registered with respect to this return mail, is mail A. The first layer mail is the mail B. Furthermore, it is assumed that a mail C is returned to the mail B. The root mail of the record registered with respect to this return mail, is mail A. The second layer mail is the mail B. The first layer mail is the mail C. Furthermore, it is assumed that a mail D is returned to the mail C. The root mail of the record registered with respect to this return mail, is mail A. The second layer mail is the mail C. The first layer mail is the mail D.

As it is clear from the above, the first layer mail is always a return mail of some mail. Therefore, in step S203, the divert candidate extracting unit 114 determines whether the message ID of the source mail is stored as the message ID of the first layer mail, in the return relationship storage unit 123.

When the source mail is not a return mail (NO in step S203), the subsequent steps are not executed, and the process of FIG. 9 is ended. Therefore, in this case, for example, the return mail creating screen 520 does not have to include the divert candidate selection area 540.

When the source mail is a return mail of some mail (YES in step S203), the divert candidate extracting unit 114 acquires, from the return relationship storage unit 123, the message ID of the root message from the record in which the source mail is the first layer mail (step S204).

For example, in the present embodiment, the message ID of the source mail is “system4@xxx.ww”. This message ID is stored as the message ID of the first layer mail, in the first record in FIG. 10. Therefore, the source mail is determined to be a return mail. Furthermore, the message ID of the root mail in the first record is “system1@xxx.ww”. Therefore, in step S204, this message ID is acquired. Note that the message ID of the second layer mail in the first record and the message ID of the root mail are the same. Accordingly, it is known that the source mail is a return mail to the root mail. Therefore, the present mail corresponds to a re-return mail.

Next, the divert candidate extracting unit 114 searches the return relationship storage unit 123 for first layer mail information of a record in which the acquired message ID is registered as the message ID of the root message information (step S205). However, the source mail is excluded from the search targets.

In the present embodiment, records in which “system1@xxx.ww” is the message ID of the root mail information, and records other than records of a source mail, correspond to second and third records in FIG. 10. Therefore, the first layer mail information of a second record and the first layer mail information of a third record, are searched.

When corresponding first layer mail information is not found (NO in step S206), subsequent steps are not executed and the process of FIG. 9 is ended. Therefore, in this case, for example, the return mail creating screen 520 does not have to include the divert candidate selection area 540.

When corresponding first layer mail information is found (YES in step S206), the divert candidate extracting unit 114 extracts, from the found first layer mail information, first layer mail information whose sender ID matches the user ID of the user satou who is the login user (step S207). That is to say, the first layer mail information relevant to the return mail whose sender is the login user, is extracted.

In FIG. 10, the sender ID (“satou@xxx.ww”) of the first layer mail information of the second record is the user ID of the user satou. Therefore, the first layer mail information of the second record is extracted. The mail relevant to the extracted first layer mail information becomes the divert candidate.

That is to say, the divert candidate is a past return mail having the same root mail as the source mail, and is a return mail that has been sent by the user who is about to send a return mail to the source mail. Referring to the second record in FIG. 10, the sender ID of the second layer mail information is “kuroda@xxx.www”. Therefore, the content that has been re-returned to the return mail from the user kuroda, is extracted as the divert candidate. In the following, the mail relevant to the first layer mail information extracted in step S208 is referred to as the divert candidate.

Note that the circumstances that have been described up to here in the present embodiment are organized as follows. In the following, each mail is expressed as “mail <character string before @ in message ID>”.

(1) The user satou has sent a mail system1, to a user kuroda, a user honda, a user yamada, a user nishikawa, a user suzuki, and a user yamano. Note that the destination of the mail system1 may be identified by the “destination” in the fourth record in the mail DB 112D (FIG. 6).
(2) The user kuroda has sent a return mail system2 including a question with respect to the mail system1. This returning of the return mail is stored in the third record in FIG. 10.
(3) The user satou has sent a re-return mail system3 to the mail system2 returned by the user kuroda.
(4) The user yamada has sent a return mail system4 including a question with respect to the mail system1. Note that the mail system4 corresponds to the source mail in the present embodiment.
(5) The user satou is about to create a re-return mail (present mail) to the mail system4.
(6) As a divert candidate for the present mail, the mail system3, which has been returned from the user satou to the user kuroda, has been extracted.

In step S207, when corresponding first layer mail information is not extracted (NO in step S208), subsequent steps are not executed and the process of FIG. 9 is ended. Therefore, in this case, for example, the return mail creating screen 520 does not have to include the divert candidate selection area 540.

Meanwhile, when corresponding first layer mail information is extracted (YES in step S208), the return mail creating screen generating unit 113 executes a divert candidate selection area generation process (step S209). The divert candidate selection area generation process is a process of generating a definition with respect to the divert candidate selection area 540 in the return mail creating screen 520. Next, the return mail creating screen generating unit 113 adds, to the screen data of the return screen 520, the definition with respect to the divert candidate selection area 540 (FIG. 8), which has been generated in the divert candidate selection area generation process (step S210). Accordingly, the screen data of the return screen 520 is completed.

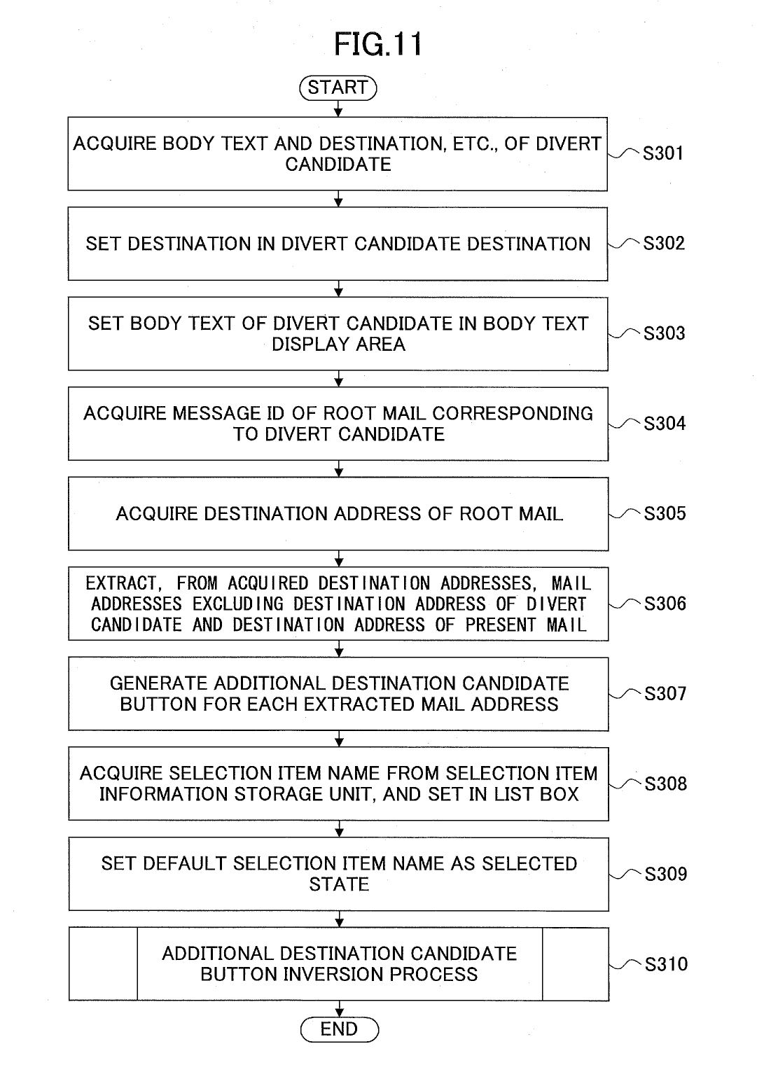

Next, a description is given of details of step S209. FIG. 11 is an example of processing procedures of the divert candidate selection area generation process.

In step S301, the return mail creating screen generating unit 113 acquires the body text and the destination of the divert candidate, from the mail DB 112D of the login user. Specifically, in the mail DB 112D (FIG. 6), the body text and the destination stored in the record relevant to the message ID of the divert candidate, are acquired. The divert candidate is the mail system3, and therefore the body text and the destination of the second record in FIG. 6 are acquired. The divert candidate is mail system3, and therefore the body text and the destination of the second record in FIG. 6 are acquired.

Next, the return mail creating screen generating unit 113 sets the acquired destination and body text in the respective definitions corresponding to the divert candidate destination display area 543 and the divert text display area 545 in the screen data in the return mail creating screen 520 (FIG. 8) (steps S302, S303). Next, the return mail creating screen generating unit 113 acquires the message ID of the root mail corresponding to the divert candidate, from the return relationship storage unit 123 (step S304). That is to say, in the return relationship storage unit 123, the message ID (“system1@xxx.ww”) of the root mail information, in the record in which the first layer mail is the mail system3, is acquired.

Next, the return mail creating screen generating unit 113 acquires, from the mail DB 112D (FIG. 6) of the login user, the destination address of the mail relevant to the message ID (step S305). That is to say, the destination address of the root mail is acquired. In the present embodiment, six mail addresses are acquired from the last record in FIG. 6.

Next, the return mail creating screen generating unit 113 extracts, from the six acquired mail addresses, four mail addresses excluding the destination address of the divert candidate and the mail address that has already been set as the destination of the present mail (step S306). The six mail addresses are the mail addresses relevant to the user kuroda, the user honda, the user yamada, the user nishikawa, the user suzuki, and the user yamano. Among these, the destination address of the divert candidate is the mail address relevant to the user kuroda. Furthermore, the destination address of the present mail is the mail address relevant to the user yamada. Therefore, the four mail addresses relevant to the user honda, the user nishikawa, the user suzuki, and the user yamano are extracted.

The destination address of the divert candidate is excluded because the user kuroda relevant to the destination address of the divert candidate has received the mail to be diverted, and it is considered that there is no need to send the mail of the same contents again.

Next, the return mail creating screen generating unit 113 adds the definition of the additional destination candidate button 5442 for each of the extracted mail addresses, in the screen data of the return mail creating screen 520 (FIG. 8) (step S307). Note that for the label of each additional destination candidate button 5442, for example, a name stored in the user information storage unit 121 in association with each extracted mail address (user ID), is used.

Next, the return mail creating screen generating unit 113 acquires a list of selection item names from the selection item information storage unit 124, and sets each of the acquired selection item names in the list box 5441 in the return mail creating screen 520 (FIG. 8) (step S308).

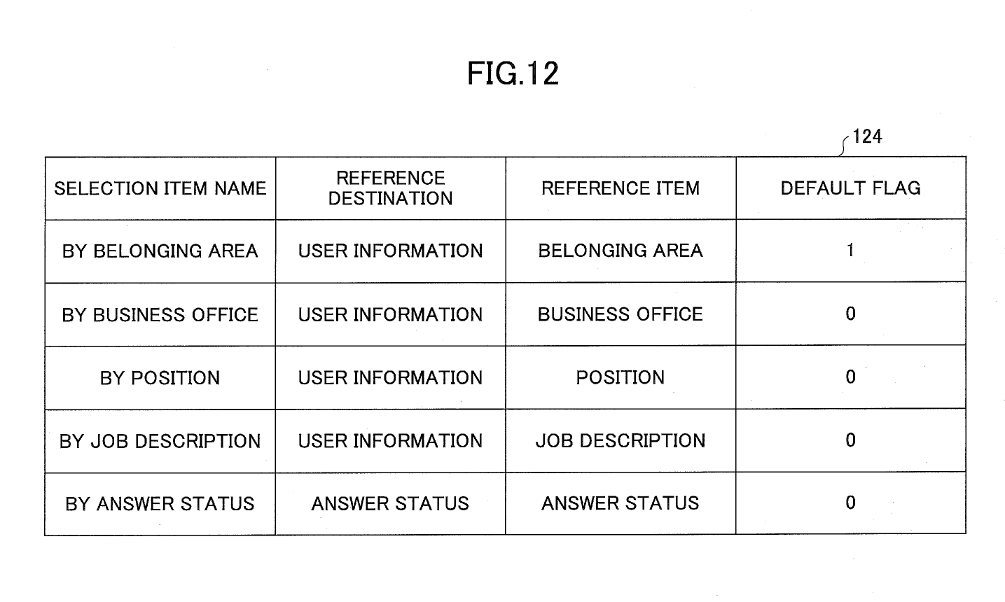

FIG. 12 is a diagram indicating a configuration example of the selection item information storage unit. In FIG. 12, the selection item information storage unit 124 stores a selection item name, a reference destination, a reference item, a default flag, etc., for each selection item in the list box 5441.

The selection item name is the name of the selection item displayed in the list box 5441. The reference destination is information to be referred to, in order to narrow down the candidates of the additional destination, when a selection item name is selected. One of the values of the reference destinations “user information”, indicates information stored in the user information storage unit 121. The reference item is an item to be referred to in order to narrow down the candidates of the additional destination, among the items constituting the information of the reference destination. For example, to the selection item name “by belonging area”, “user information” is associated as the reference destination, and “belonging area” is associated as the reference item. This means that when a selection item name “by belonging area” is selected, the candidates of the additional destination are narrowed down based on the value of the “belonging area” of the user information storage unit 121. The default flag is information identifying the selection item name that is in a selected state in the initial state of the return mail creating screen 520. In FIG. 12, the default flag for “by belonging area” is “1”. Therefore, “by belonging area” is in a selected state in the initial state of the return mail creating screen 520.

Note that in the selection item information storage unit 124, the “answer status”, which is a reference destination associated with the selection item name “by answer status”, indicates information stored in the answer status storage unit 125.

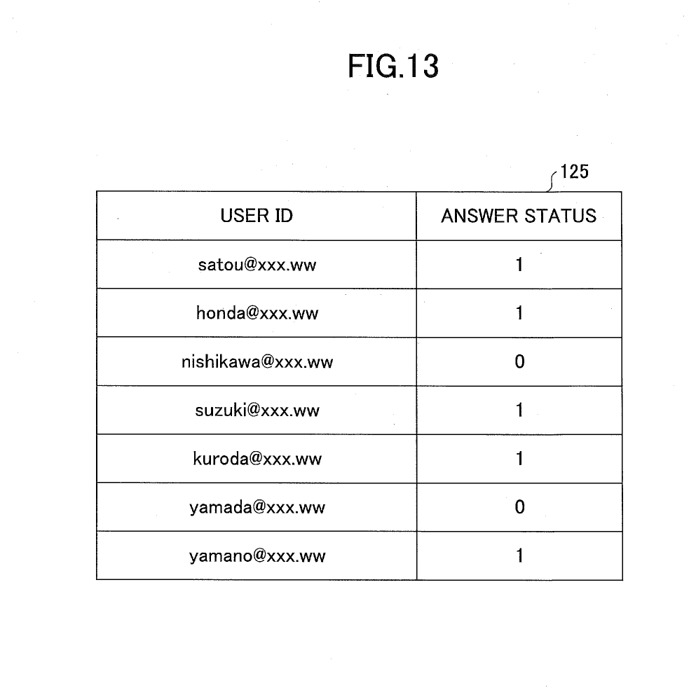

FIG. 13 is a diagram indicating a configuration example of the answer status storage unit. In FIG. 13, the answer status storage unit 125 stores the answer status for each user ID. The answer status is information indicating whether an answer has been given to a certain mail requesting an answer. “1” indicates that an answer has been given, and “0” indicates that an answer has not yet been given.

For example, the answer status storage unit 125 is generated for each mail requesting an answer, and is associated with the message ID of the mail. Therefore, when there is an answer status storage unit 125 for the root mail of the source mail, the return mail creating screen generating unit 113 sets “by answer status” as the selection item name in the list box 5441.

Note that when by answer status is selected in the list box 5441, among the additional destination candidate buttons 5442, the additional destination candidate button 5442 corresponding to the user whose value of the answer status is “0”, i.e., the user that has not yet given an answer to the root mail, is displayed in an inverted manner. Accordingly, it is possible to add the user who has not yet given an answer, to the destination.

Note that the registration of the answer status in the answer status storage unit 125 may be performed separately by another screen, etc.

Next, the return mail creating screen generating unit 113 sets the selection item name whose default flag is “1” to be in a selected state, among the selection item names set in the list box 5441 (step S309). That is to say, as the definitions relevant to the list box 5441 in the screen data of the return mail creating screen 520, a definition indicating to set the “by belonging area” to a selected state, is added.

Next, the return mail creating screen generating unit 113 executes an additional destination candidate button inversion process (step S310). The additional destination candidate button inversion process is a process of inverting the additional destination candidate button 5442, in accordance with the selected selection item name selected in the list box 5441.

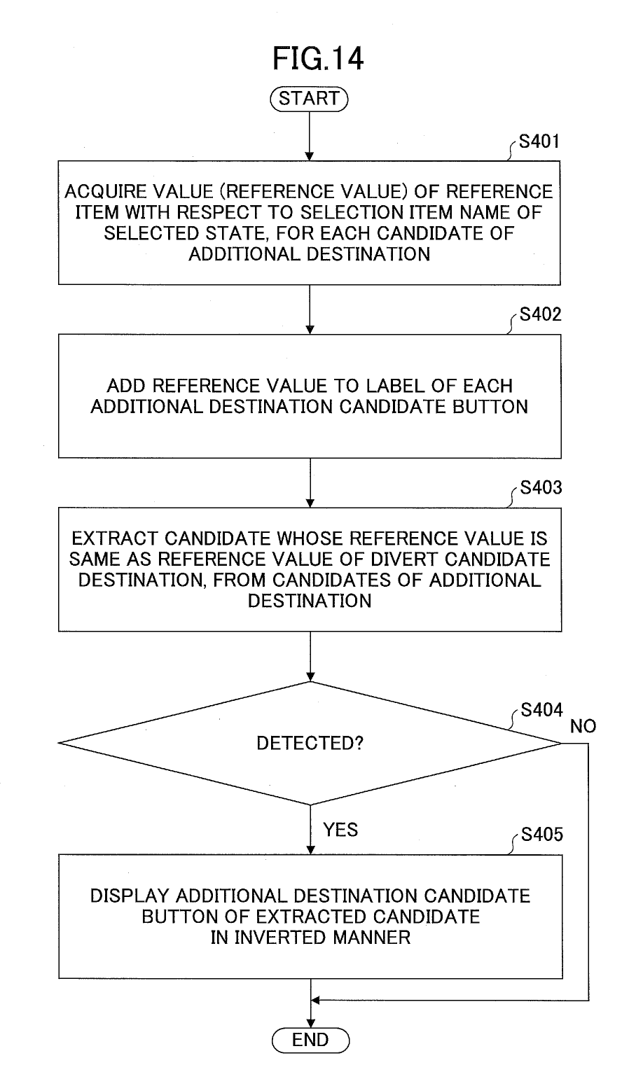

Next, a description is given of details of step S310. FIG. 14 is a flowchart for describing an example of processing procedures of the additional destination candidate button inversion process.

In step S401, the return mail creating screen generating unit 113 acquires a value of a reference item for a selection item name in a selected state in the list box 5441, with respect to a user that is a candidate of an additional destination. For example, when the selection item name in the selected state is “by belonging area”, the reference item corresponding to the selection item name is “belonging area” in the user information storage unit 121. Furthermore, the users relevant to candidates of the additional destination are the user honda, the user nishikawa, the user suzuki, and the user yamano. Therefore, the values of the “belonging area” of these four users are acquired from the user information storage unit 121. Based on the user information storage unit 121 of FIG. 5, “Kanto”, “Kanto”, “Kansai”, and “Kansai” are acquired for the user honda, the user nishikawa, the user suzuki, and the user yamano, in the stated order. In the following, the acquired values are referred to as “reference values”.

Next, the return mail creating screen generating unit 113 adds the acquired reference values to the labels of the respective additional destination candidate button 5442 (step S402). Also with respect to the additional destination candidate buttons 5442 indicated in FIG. 8, “(Kanto)” or “(Kansai)” are added. In step S402, these character strings are added.

Next, the return mail creating screen generating unit 113 extracts a candidate whose reference value matches that of the user kuroda relevant to the divert candidate destination, from among the candidates of the additional destination (step S403). The reference value with respect to the user kuroda (the value of the “belonging area” in the user information storage unit 121) is “Kansai”. Therefore, here, the user yamanao and the user suzuki, whose reference values are “Kansai”, are extracted.

When one or more candidates are extracted (YES in step S404), the return mail creating screen generating unit 113 sets the additional destination candidate button 5442 corresponding to the extracted candidate to be in an inverted display state, in the screen data of the return mail creating screen 520 (step S405).

When the screen data generated by the above process is returned to the client terminal 20, the browser unit 21 displays a return mail creating screen 520 as indicated in FIG. 8.

Note that among the candidates of the additional destination, the candidates, which have the same reference value as that of the user kuroda relevant to the divert candidate destination, are preferentially set to be selected as additional destinations. This is because these candidates are relatively highly likely to ask the same question as the user kuroda relevant to the divert candidate destination. That is to say, a user, whose attribute information is at least partially common to a user who has made the question in the past, is considered to be highly likely to ask the same question. The user may determine which one of the attribute items is to be common in order to consider that the user is likely to ask the same question, based on the contents of the body text, etc., of the divert candidate.

In the present embodiment, the body text of the divert candidate is “This is satou. Reception room 1 is at the back on the tenth floor of our company.” That is to say, the divert candidate is an answer to a question asking where reception room 1 is. The belonging area of the user satou is the Kanto district, and it is assumed that reception room 1 is a reception room that is at one of the business offices in the Kanto district. Therefore, it is assumed that the user kuroda, whose belonging area is the Kansai district, did not know the location of reception room 1. Thus, it is predicted that the user yamano and the user suzuki, whose belonging area is also the Kansai district, will also return a mail including a similar question in the body text. Thus, the user satou needs to return a mail including the same answer again, to these users. Accordingly, in the present embodiment, a user, whose attribute information is at least partially common to the user that is the destination of the divert candidate, is included in the destination of the present mail. By doing so, the answer may be sent before the question comes.

Note that in step S403, the candidates whose reference values match that of the user yamada that is the transmission source of the source mail may be extracted from among the candidates of the additional destination. This is because the user yamada, who is the transmission source of the source mail, is a user who has asked the same question as that of the user kuroda relevant to the divert candidate destination.

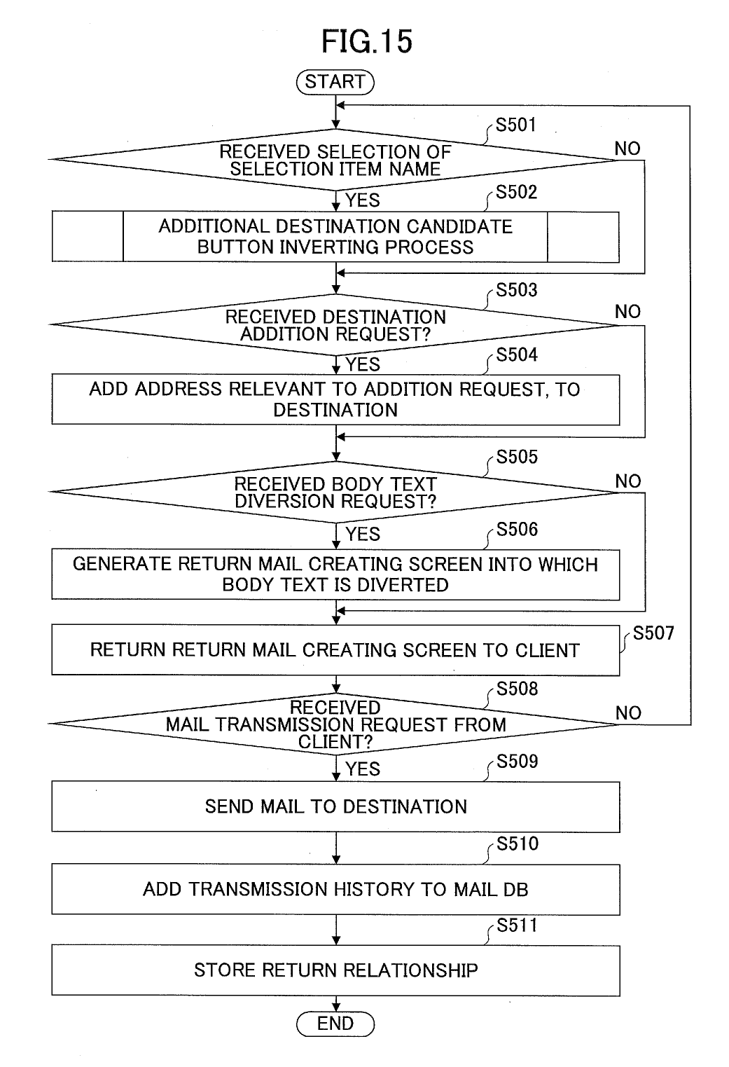

Next, a description is given of details of step S111 in FIG. 4. FIG. 15 is a flowchart for describing the processing procedures of a return mail creating screen operation process. That is to say, FIG. 15 indicates a process that is executed according to operations by the user with respect to the return mail creating screen 520, in a state where the return mail creating screen 520 is displayed on the client terminal 20.

For example, when a selection item name selected in the list box 5441 of the return mail creating screen 520 (FIG. 8) is changed, the browser unit 21 specifies a selection item name that is newly selected, and sends a selection report of the selection item name, to the mail server 10.

When the request receiving unit 117 of the mail server 10 receives the selection report of the selection item name (YES in step S501), the return mail creating screen generating unit 113 executes the additional destination candidate button inversion process described with reference to FIG. 14 (step S502). As a result, with respect to the reference value corresponding to the selection item name that has been newly selected, the additional destination candidate button 5442, which corresponds to the candidate of the additional destination matching the user relevant to the destination of the divert candidate, turns into an inverted state. The response returning unit 118 returns, to the client terminal 20, a response including the screen data of the return mail creating screen 520, to which the result of the inversion process has been applied (step S507).

Furthermore, when the destination addition button 5443 of the return mail creating screen 520 (FIG. 8) is pressed, the browser unit 21 specifies the user ID corresponding to the additional destination candidate button 5442 in an inverted state, and sends a destination addition request to the mail server 10.

When the request receiving unit 117 of the mail server 10 receives the destination addition request (YES in step S503), the return mail creating screen generating unit 113 sets the user ID (i.e., the mail address) specified in the destination addition request, in the definition of the destination input area 531 of the screen data of the return mail creating screen 520 (step S504). The response returning unit 118 returns, to the client terminal 20, a response including the screen data of the return mail creating screen 520 in which the destination has been added (step S507).

Furthermore, when the body text divert button 5451 of the return mail creating screen 520 (FIG. 8) is pressed, the browser unit 21 specifies the message ID of the divert candidate, and sends a body text diversion request to the mail server 10.

When the request receiving unit 117 of the mail server 10 receives the body text diversion request (YES in step S505), the return mail creating screen generating unit 113 sets the body text corresponding to the message ID specified in the body text diversion request, in the definition of the body text input area 534 of the screen data of the return mail creating screen 520 (step S506). The body text corresponding to the message ID is the body text stored in the mail DB 112D in association with the message ID.

The response returning unit 118 returns, to the client terminal 20, a response including the screen data of the return mail creating screen 520 into which the body text of the divert candidate has been diverted (step S507).

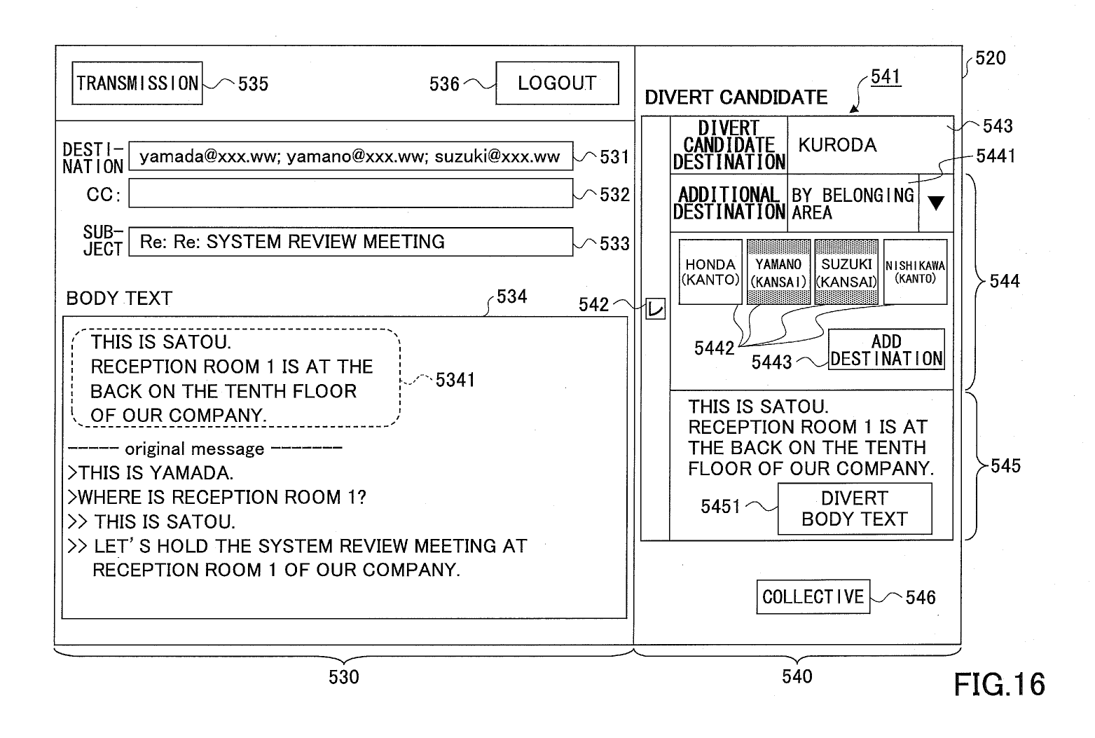

As a result of the above process, the state of the return mail creating screen 520 displayed on the client terminal 20 becomes as indicated in FIG. 16, for example.

FIG. 16 is a diagram indicating a display example of the return mail creating screen to which the destination has been added and the body text has been diverted. In FIG. 16, the same parts as those in FIG. 8 are denoted by the same reference numerals, and descriptions thereof are omitted.

In the return mail creating screen 520 indicated in FIG. 16, in the destination input area 531, the mail addresses of the user yamano and the user suzuki are added. Furthermore, in the body text input area 534, a body text 5341 that is a divert candidate is copied.

As described above, the user satou is able to complete a return mail to a source mail including the question from the user yamano, without inputting any character strings in the body text, or by inputting a small number of characters.

In the return mail creating screen 520 of FIG. 16, when the transmission button 535 is pressed by the user, the browser unit 21 sends a request to send a mail, to the mail server 10. In the request to send a mail, the message ID, the subject, the body text, the destination, etc., of the present mail are specified. Note that the message ID of the present mail is, for example, assigned by the return mail creating screen generating unit 113, when the return mail creation request is received in step S108.

When the request receiving unit 117 of the mail server 10 receives the request to send a mail (YES in step S508), the mail transmitting unit 116 sends a mail including the subject and body text specified in the request, to the destination specified in the request (step S509). When the destination address of the mail is a mail address in the mail system 1, the transmission of the mail is realized by registering information relevant to the mail, in the mail DB 112D corresponding to the destination address.

Next, the mail transmitting unit 116 adds a transmission history to the mail DB 112D of the login user (step S510). That is to say, the type, the message ID, the sender ID, the time and date, the subject, the text body, the destination, etc., of the present mail, are stored in the mail DB 112D (FIG. 6) of the login user. The value of the type is “transmission”. The sender ID is the user ID of the login user. The time and date are the present time and date.

Next, the return relationship registration unit 115 stores the record relevant to the current return mail, in the return relationship storage unit 123 (step S511). In the first layer mail information of the record, the message ID of the present mail and the user ID of the login user are stored. In the second layer mail information, the message ID of the source mail and the user ID of the sender of the source mail (user ID of the user yamada) are stored. In the root mail information, the root mail information stored in association with the source mail, is stored. That is to say, the root mail information of the first record in FIG. 10 is copied into the root mail information of the record that is newly generated.

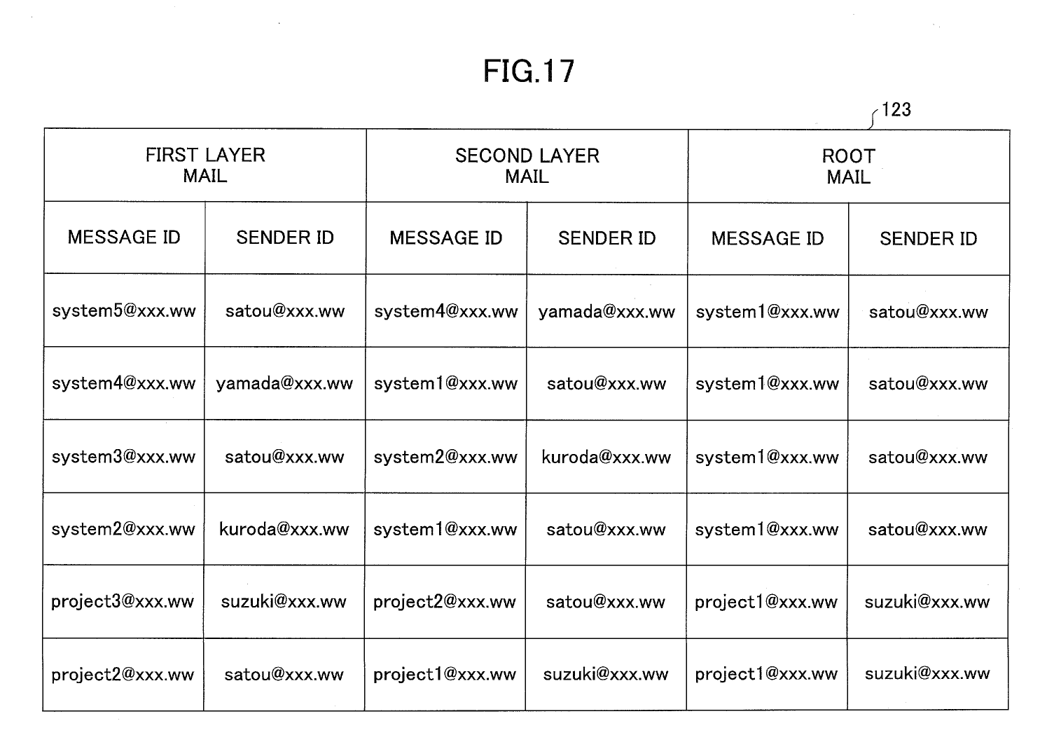

As a result, the state of the return relationship storage unit 123 becomes as indicated in FIG. 17. FIG. 17 is a diagram indicating an example of the state of the return relationship storage unit after the present mail has been returned. In FIG. 17, the record in the first line (new first record) is an example of the record that is stored in step S511.

As described above, according to the present embodiment, when creating a return mail, a past return mail, which has the same root mail as the source mail to which a mail is to be returned, is automatically extracted as the divert candidate. Therefore, the user is able to complete the return mail by selecting a desired divert candidate from among the extracted divert candidates. As a result, the load of creating a return mail is reduced.

Furthermore, as the destination of a return mail that is newly created, it is possible to easily add any one of a plurality of destinations of the root mail. Therefore, it is possible to reduce, in advance, the possibility of mails, which include the same question based on the root mail, being repeatedly sent from a plurality of persons.

Particularly, when a user, whose attribute information is at least partially common to a user that is the destination of the divert candidate or a user that is the transmission source of the source mail, is extracted as the destination to be added. Therefore, it is possible to send a return mail including an answer to a predicted question, to a user who is highly likely to ask the same question as a user that is the destination of the divert candidate or a user that is the transmission source of the source mail.

Note that in the present embodiment, the mail server 10 is an example of a mail extraction device. The return relationship storage unit 123 is an example of a storage unit.

Embodiments of the present invention have been described in detail above; however, the present invention is not limited to the specific embodiments described herein, and a variety of modifications and changes may be made without departing from the scope of the present invention.

According to one embodiment, it is possible to reduce the load in creating a return mail.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mail extraction method for causing a computer to execute a process comprising:
storing, in association with each other in a storage unit, a first mail sent to a plurality of destinations, a first return mail from a first destination among the plurality of destinations, and a first re-return mail that is returned to the first return mail; and
displaying, on a display unit, the first re-return mail stored in the storage unit in association with the first mail, in response to a request to create a second re-return mail to a second return mail from a second destination among the plurality of destinations of the first mail.

2. The mail extraction method according to claim 1, the process further comprising:
adding a destination among the plurality of destinations, to a destination of the second re-return mail.

3. The mail extraction method according to claim 2, wherein
the adding includes adding, to the destination of the second re-return mail, a mail address relevant to a user whose attribute information is at least partially common to a user relevant to a mail address of the first destination or a user relevant to a mail address of the second destination, among mail addresses of the plurality of destinations, by referring to a user information storage unit that stores, for respective mail addresses, attribute information of users relevant to the mail addresses.

4. A mail extraction device comprising:
a processor configured to execute a process including
storing, in association with each other in a storage unit, a first mail sent to a plurality of destinations, a first return mail from a first destination among the plurality of destinations, and a first re-return mail that is returned to the first return mail; and
displaying, on a display unit, the first re-return mail stored in the storage unit in association with the first mail, in response to a request to create a second re-return mail to a second return mail from a second destination among the plurality of destinations of the first mail.

5. The mail extraction device according to claim 4, wherein the process further includes
adding a destination among the plurality of destinations, to a destination of the second re-return mail.

6. The mail extraction device according to claim 5, wherein
the adding includes adding, to the destination of the second re-return mail, a mail address relevant to a user whose attribute information is at least partially common to a user relevant to a mail address of the first destination or a user relevant to a mail address of the second destination, among mail addresses of the plurality of destinations, by referring to a user information storage unit that stores, for respective mail addresses, attribute information of users relevant to the mail addresses.

7. A non-transitory computer-readable recording medium storing a program that causes a computer to execute a process, the process comprising:
storing, in association with each other in a storage unit, a first mail sent to a plurality of destinations, a first return mail from a first destination among the plurality of destinations, and a first re-return mail that is returned to the first return mail; and
displaying, on a display unit, the first re-return mail stored in the storage unit in association with the first mail, in response to a request to create a second re-return mail to a second return mail from a second destination among the plurality of destinations of the first mail.

8. The non-transitory computer-readable recording medium according to claim 7, the process further comprising:
adding a destination among the plurality of destinations, to a destination of the second re-return mail.

9. The non-transitory computer-readable recording medium according to claim 8, wherein
the adding includes adding, to the destination of the second re-return mail, a mail address relevant to a user whose attribute information is at least partially common to a user relevant to a mail address of the first destination or a user relevant to a mail address of the second destination, among mail addresses of the plurality of destinations, by referring to a user information storage unit that stores, for respective mail addresses, attribute information of users relevant to the mail addresses.
